(19) United States
(12) Patent Application Publication
(10) Pub. No.: US 2014/0230549 A1
(43) Pub. Date: Aug. 21, 2014

(54) SPRING SYSTEM FOR MEMS DEVICE

(71) Applicants: Andrew C. McNeil, Chandler, AZ (US); Gary G. Li, Chandler, AZ (US)

(72) Inventors: Andrew C. McNeil, Chandler, AZ (US); Gary G. Li, Chandler, AZ (US)

(73) Assignee: Freescale Semiconductor, Inc.

(21) Appl. No.: 13/770,224

(22) Filed: Feb. 19, 2013

(51) Int. Cl. G01C 19/5684; G01C 25/00

(52) U.S. Cl. CPC G01C 19/5684; G01C 25/00
USPC 73/504.13; 29/592.1

(57) ABSTRACT

A spring system (74) links a pair of drive masses (30, 32) of a MEMS device (72). The spring system (74) includes stiff beams (76, 78, 80, 82) oriented to form a parallelogram arrangement (84). The beams are oriented diagonal to a drive direction (56) of the masses (30, 32). Diagonally opposing corners (86, 88) of the parallelogram arrangement (84) are coupled to the drive masses (30, 32). A spring (90) is coupled to a corner (94) and a spring (92) is coupled to a diagonally opposing corner (96) of the parallelogram arrangement. The springs (90, 92) are interconnected with a sense frame (34) surrounding the drive masses. The beams and side springs are stiff to substantially prevent in-phase motion (66) of the drive masses. However, rotationally compliant flexures (102, 104, 106, 108), allow the arrangement (84) to collapse and expand to enable anti-phase motion (60) of the drive masses.

### TECHNICAL FIELD OF THE INVENTION

The present invention relates generally to microelectromechanical systems (MEMS) devices. More specifically, the present invention relates to a MEMS device that is insusceptible to in-phase motion.

### BACKGROUND OF THE INVENTION

Microelectromechanical systems (MEMS) technology has achieved wide popularity in recent years, as it provides a way to make very small mechanical structures and integrate these structures with electrical devices on a single substrate using conventional batch semiconductor processing techniques. One common application of MEMS is the design and manufacture of sensor devices. MEMS sensor devices are widely used in applications such as automotive, inertial guidance systems, household appliances, game devices, protection systems for a variety of devices, and many other industrial, scientific, and engineering systems. One example of a MEMS sensor is a MEMS angular rate sensor. An angular rate sensor senses angular speed or velocity around one or more axes.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a top view of a prior art angular rate sensor;

FIG. 2 shows a conceptual model of the drive masses for the prior art angular rate sensor under two modes of operation;

FIG. 3 shows a top view of an angular rate sensor in accordance with an embodiment;

FIG. 4 shows a top view of a portion of the angular rate sensor of FIG. 3;

FIG. 5 shows a conceptual model of drive masses for the angular rate sensor of FIG. 3 coupled via a spring system in accordance with an embodiment;

FIG. 6 shows the conceptual model of FIG. 5 demonstrating anti-phase motion of the drive masses in a first direction; and

FIG. 7 shows the conceptual model of FIG. 5 demonstrating anti-phase motion of the drive masses in a second direction.

### DETAILED DESCRIPTION

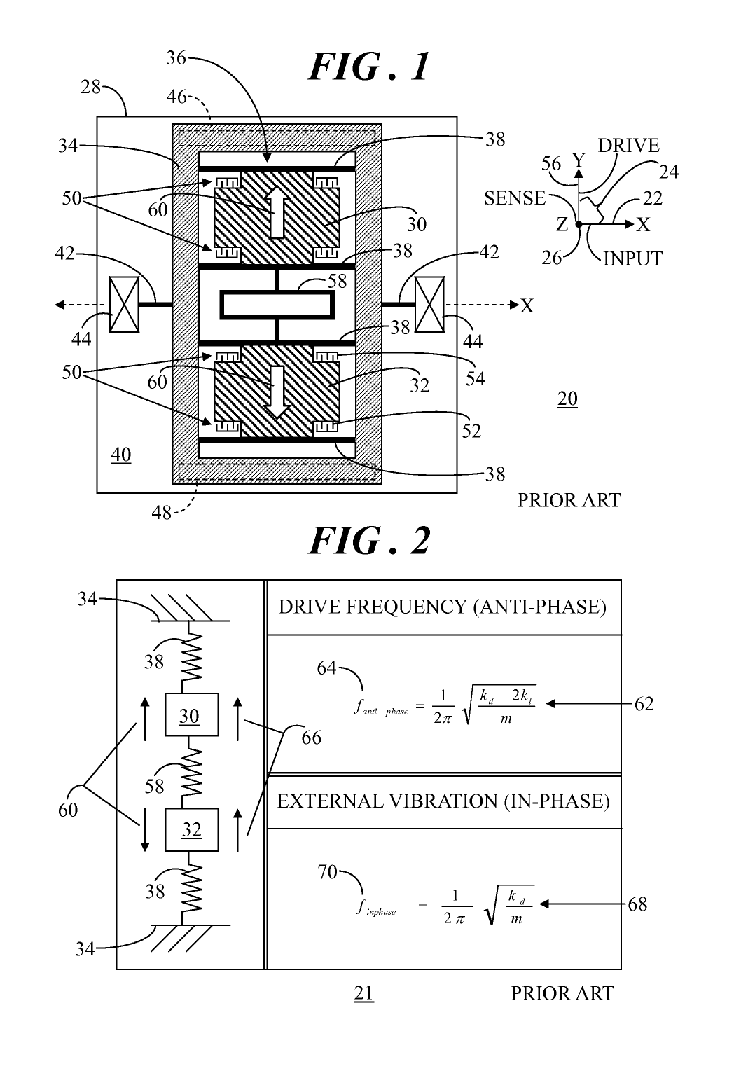

Referring to FIGS. 1 and 2, FIG. 1 shows a top view of a prior art angular rate sensor 20 and FIG. 2 shows a conceptual model 21 of the drive masses for the prior art angular rate sensor 20 under two modes of operation. Prior art angular rate sensor 20 is provided herein to illustrate unwanted in-phase motion that may occur in prior art designs. Angular rate sensor 20 is generally configured to sense angular rate about an axis of rotation referred to as an input axis 22. In the illustrated configuration, input axis 22 is the X-axis in a three-dimensional coordinate system. By convention, angular rate sensor 20 is illustrated as having a generally planar structure within an X-Y plane 24, wherein a Z-axis 26 extends out of the page, normal to X-Y plane 24 in FIG. 1.

Angular rate sensor 20 includes a substrate 28, a drive mass 30, another drive mass 32, a sense mass 34, and various mechanical linkages. In the example of FIG. 1, sense mass 34 is a sense frame, and drive masses 30 and 32 reside in a central opening 36 extending through sense mass 34. Drive mass 32 is disposed laterally in X-Y plane 24 from drive mass 30, and drive masses 30 and 32 are situated symmetrically relative to one another about input axis 22.

Link spring components 38 couple each of drive masses 30 and 32, respectively, to sense mass 34. As such, drive masses 30 and 32 are suspended above a surface 40 of substrate 28 and do not have a direct physical attachment to substrate 28. Angular rate sensor 20 further includes flexible support elements in the form of torsion springs 42 coupled to sense mass 34. Torsion springs 42 connect sense mass 34 to surface 40 of substrate 28 via anchors 44.

A variety of conductive plates, or electrodes, may be formed on surface 40 of substrate 28 in conjunction with the other fixed components of angular rate sensor 20. In this simplified illustration, the electrodes include sense electrodes 46 and 48, used to sense the rotation of angular rate sensor 20 about X-axis 22. Electrodes 46 and 48 are obscured in FIG. 1 by the overlying sense mass 34. Accordingly, in FIG. 1, electrodes 46 and 48 are represented in dashed line form to illustrate their physical placement relative to sense mass 34.

A drive system 50 resides in central opening 36. Drive system 50 includes sets of drive elements configured to oscillate drive masses 30 and 32. Each set of drive elements includes pairs of electrodes, referred to as movable fingers 52 and fixed fingers 54. In the illustrated example, movable fingers 52 are coupled to and extend from each of drive masses 30 and 32 and fixed fingers 54 are fixed to surface 40 of substrate 28. Fixed fingers 54 are spaced apart from and positioned in alternating arrangement with movable fingers 52. By virtue of their attachment to drive masses 30 and 32, movable fingers 52 are movable together with drive masses 30 and 32. Conversely, due to their fixed attachment to substrate 28, fixed fingers 54 are stationary relative to movable fingers 52.

Drive masses 30 and 32 may be configured to undergo oscillatory motion within X-Y plane 24. In general, an alternating current (AC) voltage, as a drive signal, may be applied to fixed fingers 54 via a drive circuit (not shown) to cause drive masses 30 and 32 to oscillate along a drive axis 56, i.e., the Y-axis, in the three dimensional coordinate system. Drive masses 30 and 32 are linked together via a coupling spring 58 to move in opposite directions, i.e., anti-phase, along Y-axis 56.

In operation, drive system 50 imparts oscillatory linear motion on drive masses 30 and 32 within X-Y plane 24 in anti-phase. In the illustrated embodiment, wherein the axis of rotation is designated as X-axis 22, drive masses 30 and 32 oscillate in opposite directions approximately parallel to Y-axis 46 (i.e., up and down in FIG. 1). Anti-phase movement of drive masses 30 and 32 is represented in FIGS. 1 and 2 by oppositely pointing arrows 60, and is thus referred to herein as anti-phase motion 60. Once drive masses 30 and 32 are put into oscillatory motion (i.e., anti-phase motion 60) along Y-axis 46, the system of masses 30, 32, and 34 is capable of detecting angular rate, i.e., angular velocity, induced by angular rate sensor 20 being rotated about X-axis 22. In particular, as a result of a Coriolis acceleration component, torsion springs 42 enable sense mass 34 to oscillate out of X-Y plane 24 by pivoting about torsion springs 42 as a function of angular rate, i.e., the angular velocity, of angular rate sensor 20 about X-axis of rotation 22. This movement has an amplitude that is proportional to the angular rotation rate of angular rate sensor 20 about the input axis, i.e., X-axis 22, which is sensed at electrodes 46 and 48.

With particular reference to conceptual model 21 of FIG. 2, angular rate sensor 20 (FIG. 1) is represented by drive masses 30 and 32 linked by coupling spring 58, and link spring components 38 that couple drive masses 30 and 32 to sense mass 34. The system of springs 38 and 58 enable anti-phase motion 60 of drive masses 30 and 32. An equation 62 represents an anti-phase drive frequency component 64 for anti-phase motion 60 imparted on drive masses 30 and 32.

Drive masses 30 and 32 can be subjected to in-phase movement due to external vibration, shock, interference, and the like. In-phase movement refers to a condition in which the two drive masses 30 and 32 oscillate in the same direction at the same amplitude. In-phase movement of drive masses 30 and 32 is represented in FIG. 2 by a pair of arrows 66 pointing in the same direction, and is thus referred to herein as in-phase motion 66. In-phase motion 66 is disadvantageous in angular rate sensor 20. Indeed, external vibration at the resonant frequency of the undesired in-phase mode can produce significant in-phase motion 66 thus causing uncontrollable large motion of drive masses 30 and 32 leading to inaccuracy of an angular rate sensor. Unfortunately, the system of springs 38 and 58 in the exemplary prior art design may allow for the undesired in-phase motion 66 of drive masses 30 and 32. An equation 68 represents an in-phase frequency component 70 for in-phase motion 66 imparted on drive masses 30 and 32.

Embodiments disclosed herein entail a spring system for a microelectromechanical systems (MEMS) device, a MEMS device including the spring system, and a method of fabricating the MEMS device having the spring system. In particular, a MEMS angular rate sensor includes a spring system coupling a pair of drive masses that enables fundamental “tuning fork” anti-phase motion of the drive masses. The spring system includes a rectangular structure of diagonally oriented stiff beams coupled to the drive masses. The spring system further includes side springs interconnected between the rectangular structure and a surrounding sense frame that are stiff in the direction of drive motion, but compliant in a direction orthogonal to the direction of the drive motion. The diagonally arranged beams are linked to the side springs with rotationally compliant flexures. The resulting structure constrains the motion of the drive masses to anti-phase oscillation and provides stiff resistance to in-phase oscillation of the drive masses. Although a MEMS angular rate sensor is described herein, it should be understood that the spring system may be adapted for use in other MEMs devices implementing dual movable drive masses that are to be driven in anti-phase, and for which in-phase motion is to be suppressed.

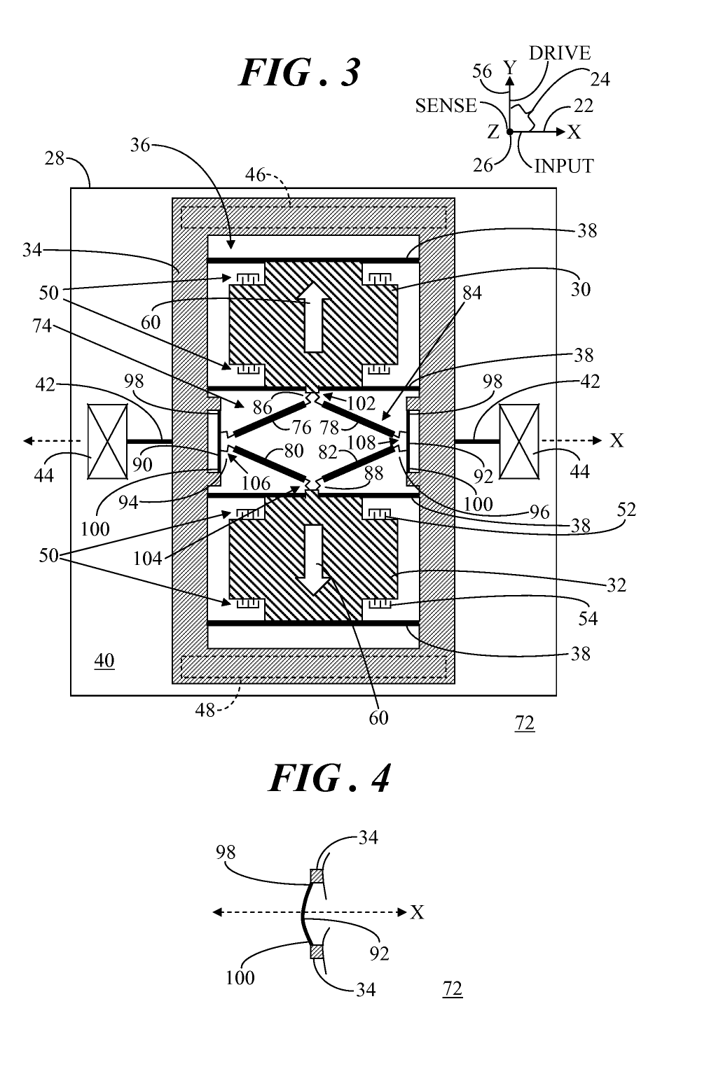

Referring to FIGS. 3-4, FIG. 3 shows a top view of an angular rate sensor 72 in accordance with an embodiment, and FIG. 4 shows a top view of a portion of angular rate sensor 72. Like angular rate sensor 20, angular rate sensor 72 is generally configured to sense angular rate about an axis of rotation referred to as input axis 22, i.e. the X-axis, where drive axis 56 is the Y-axis, and sense axis 26 is the Z-axis. Many of the components of angular rate sensor 72 are the same as for angular rate sensor 20. As such, the same references numbers will be utilized for the same elements and a description of their structure and function will not be repeated. However, in accordance with an embodiment, coupling spring 58 (FIG. 1) is replaced by a spring system 74. Spring system 74 is configured to reduce in-phase motion 66 of drive masses 30 and 32.

Spring system 74 includes a set of stiff beams, the set including a first beam 76, a second beam 78, a third beam 80, and a fourth beam 82. Beams 76, 78, 80, and 82 are oriented diagonal to, i.e. slanted obliquely relative to, a drive direction of drive masses 30 and 32. That is, beams 76, 78, 80, and 82 are oriented diagonal to drive axis 56. The term “diagonal” used herein refers to a configuration in which each of beams 76, 78, 80, and 82 are not arranged parallel to the drive direction of drive masses 30 and 32, and beams 76, 78, 80, and 82 are not arranged perpendicular to the drive direction of drive masses 30 and 32. Instead, beams 76, 78, 80, and 82 may be slanted obliquely, although they are not limited to a forty-five degree slant relative to the drive direction. The terms “first,” “second,” “third,” and so forth used herein do not refer to an ordering or prioritization of elements within a countable series of elements. Rather, the terms “first,” “second,” “third,” and so forth are used to distinguish certain elements, or groups of elements, from one another for clarity of discussion.

Beams 76, 78, 80, and 82 are oriented relative to one another to form a parallelogram arrangement 84. As such, first and fourth beams 76 and 82 are generally equal in length and parallel to one another. Likewise, second and third beams 78 and 80 are generally equal in length and parallel to one another. The parallelogram arrangement 84 of beams 76, 78, 80, and 82 includes four corners. A first corner 86 of parallelogram arrangement 84 is configured to couple to drive mass 30, and a second corner 88 of parallelogram arrangement 84 is configured to couple drive mass 32, where second corner 88 is diagonally opposite to first corner 86.

Spring system 74 further includes a first side spring 90 and a second side spring 92. First side spring 90 is coupled to a third corner 94 of parallelogram 84, and second side spring 92 is coupled to a fourth corner 96 of parallelogram 84, where fourth corner 96 is diagonally opposite to third corner 94. Opposing ends 98 and 100 of each of first and second side springs 90 and 92 interconnect with the frame structure of sense mass 34. In an embodiment, first and second side springs 90 and 92, respectively, are stiff in a drive direction of drive masses 30 and 32. That is, first and second side springs 90 and 92 are thin in the X-direction as compared to their length in the Y-direction. Accordingly, first and second side springs 90 and 92 are resistant to bending in a drive direction that is parallel to drive axis 56. However, first and second side springs 90 and 92 are compliant, i.e., are able to bend, flex, or otherwise deform, in another direction that is parallel to X-Y plane 24. Thus, first and second side springs 90 and 92 are compliant in a direction that is substantially parallel to X-axis 22. As such, first and second side springs 90 and 92 do not allow motion in the drive direction, parallel to drive axis 56. Rather, first and second side springs 90 and 92 allow motion in another direction that is parallel to X-axis 22. This compliance is particularly exemplified in FIG. 4.

Spring system 74 further includes a first flexure arrangement 102 interconnecting first and second beams 76 and 78, respectively, of parallelogram arrangement 84 at first corner 86. Likewise, a second flexure arrangement 104 interconnects third and fourth beams 80 and 82, respectively, at second corner 88. A third flexure arrangement 106 interconnects first beam 76 and third beam 80 at third corner 94. And, a fourth flexure arrangement 108 interconnects second beam 78 and fourth beam 82 at fourth corner 96. Each of flexure arrangements 102, 104, 106, and 108 is rotationally compliant about an axis that is substantially perpendicular to the planar surface 40 of substrate 28. That is, each of flexure arrangements 102, 104, 106, and 108 are formed from any suitable spring configuration that allows for rotation about Z-axis 26. However, flexure arrangements 102, 104, 106, and 108 are axially stiff, i.e., are prevented from linear movement parallel to Z-axis 26, so that the rotational movement of flexure arrangements 102, 104, 106, 108 is constrained to X-Y plane 24.

Additionally, the spring constants of beams 76, 78, 80, and 82 can be tuned to be much stiffer than that of flexure arrangements 102, 104, 106, 108 so that beams 76, 78, 80, and 82 are largely non-compliant and flexure arrangements are more compliant than 76, 78, 80, and 82. For example, the width of beams 76, 78, 80, and 82 in X-Y plane 24 may be significantly greater than the width of any of flexure arrangements 102, 104, 106, and 108 in X-Y plane.

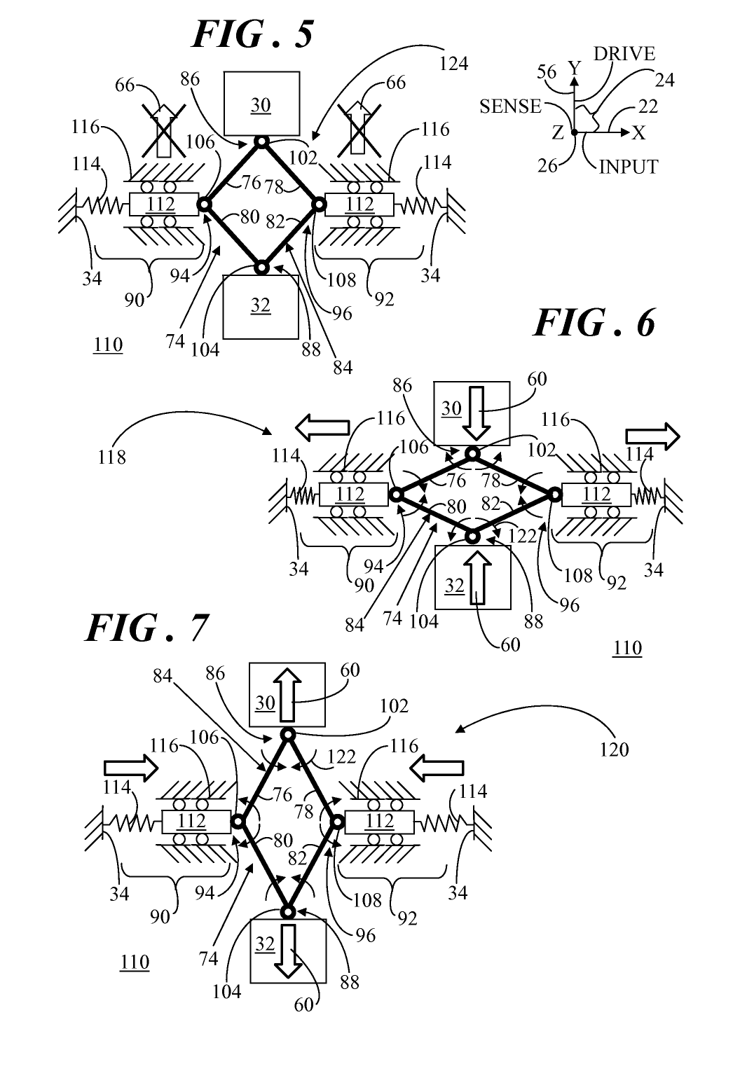

FIG. 5 shows a conceptual model 110 of drive masses 30, 32 for angular rate sensor 72 (FIG. 3) coupled via spring system 74 in accordance with an embodiment. In conceptual model 110, first and second side springs 90 and 92 are each represented by an element 112 and a spring 114. As described above, first and second side springs 90 and 92 (represented by element 112 and spring 114) interconnect parallelogram arrangement 84 of stiff beams 76, 78, 80, and 82 with sense frame 34.

As discussed previously, first and second side springs 90 and 92 are stiff, i.e., non-compliant, in the Y-direction parallel to Y-axis 56. This stiffness is represented in conceptual model 110, by element 112 being constrained by fixed structures 116. However, spring 114 represents the ability of each of first and second side springs 90 and 92 to move, i.e., stretch, compress, or otherwise deform, in a direction parallel to X-axis 22.

The stiffness of beams 76, 78, 80, and 82, as well as the stiffness of first and second side springs 90 and 92 in the Y-direction, provide mechanical constraint to in-phase motion 66 at the resonant frequency, i.e., the operating frequency, of angular rate sensor 72. Thus, in-phase motion 66 of drive masses 30 and 32 due to external vibration, spurious acceleration, or interference is largely prevented. The mechanical constraint of spring system 74 can push the in-phase frequency component 70 (FIG. 2) due to in-phase motion 66 sufficiently high so that in-phase frequency component 70 is outside of the operating range of angular rate sensor 72.

Referring to FIGS. 6 and 7, FIG. 6 shows conceptual model 110 demonstrating anti-phase motion 60 of drive masses 30 and 32 in a first direction 118, and FIG. 7 shows conceptual model 110 demonstrating anti-phase motion 60 of drive masses 30 and 32 in a second direction 120. Drive masses 30 and 32 are driven into anti-phase motion 60 via drive system 50, as discussed above in connection with FIG. 1.

In FIG. 6, a drive signal from drive system 50 moves drive masses 30 and 32 in first direction 118 toward one another. As drive masses 30 are driven toward one another, flexure arrangements 102, 104, 106, and 108 enable rotational movement of beams 76, 78, 80, and 82, as represented by arrows 122, so that side springs 90 and 92 deform in the X-direction and parallelogram arrangement 84 collapses, i.e., compresses, in the drive direction. In FIG. 7, the drive signal from drive system 50 moves drive masses 30 and 32 in second direction 120 away from one another. As drive masses 30 are driven away from one another, flexure arrangements 102, 104, 106, and 108 again enable rotational movement 122 of beams 76, 78, 80, and 82, so that side springs 90 and 92 deform in the X-direction and parallelogram arrangement 84 expands in the drive direction. Thus, oscillatory anti-phase motion 60 of first and second drive masses 30 and 32 is enabled, while in-phase motion 66 (FIG. 5) is substantially prevented. Furthermore, parallelogram arrangement 84 is constrained to a non-collapsed configuration 124 (FIG. 5) when subjected to an external vibration due to the non-compliance of first and second side springs 90 and 92 in the Y-direction.

Referring back to FIG. 3, a method of fabricating angular rate sensor 72 generally entails forming first drive mass 30, second drive mass 32, and sense mass 34 surrounding drive masses 30 and 32 suspended above surface 40 of substrate 28. Spring system 74 is formed to include the set of stiff (e.g., relatively thick in X-Y plane 24) beams 76, 78, 80, and 82 oriented relative to one another to form parallelogram structure 84, and formed to include first and second side springs 90 and 92, respectively. The fabrication of angular rate sensor 72 results in spring system 74 being coupled to drive masses 30 and 32 such that beams 76, 78, 80, and 82 are oriented diagonal to drive direction 56 of drive masses 30 and 32. The fabrication of angular rate sensor 72 further results in first corner 86 of parallelogram arrangement 84 being interconnected with first drive mass 30 and second corner 88 of parallelogram arrangement 84 being interconnected with second drive mass 32, where second corner 88 is diagonally opposite said first corner. The fabrication of angular rate sensor 72 further also results in first side spring 90 being interconnected with third corner 94 of parallelogram arrangement 84 and second side spring 92 being interconnected with fourth corner 96 of parallelogram arrangement 84, where fourth corner 96 is diagonally opposite third corner 94. Additionally, the interconnection of suitable flexure arrangements 102, 104, 106, and 108 occurs, and the interconnection of opposing ends 98 and 100 of side springs 90 and 92 to sense mass 34 occurs during fabrication.

Fabrication of angular rate sensor 72 may be performed using any suitable known or upcoming fabrication process. For example, a fabrication process implements a silicon micromachining fabrication process that results in structural layers and sacrificial layers that are appropriately deposited, patterned, and etched to produce the suspended structures of angular rate sensor 72.

In summary, embodiments entail a spring system for a microelectromechanical systems (MEMS) device, a MEMS device including the spring system, and a method of fabricating the MEMS device having the spring system. In particular, a MEMS angular rate sensor includes a spring system coupling a pair of drive masses that enables fundamental anti-phase motion of the drive masses. The spring system includes a parallelogram arrangement of diagonally oriented stiff beams coupled to the drive masses. The spring system further includes side springs interconnected between the parallelogram arrangement and a surrounding sense frame that are stiff in the direction of drive motion, but compliant in a direction orthogonal to the direction of the drive motion. The diagonally arranged beams are linked to the side springs with rotationally compliant flexures. The resulting structure constrains the motion of the drive masses to anti-phase oscillation and provides stiff resistance to in-phase oscillation of the drive masses. Consequently, greater accuracy of the signal output can be achieved.

Although the preferred embodiments of the invention have been illustrated and described in detail, it will be readily apparent to those skilled in the art that various modifications may be made therein without departing from the spirit of the invention or from the scope of the appended claims. That is, it should be appreciated that the exemplary embodiments are only examples, and are not intended to limit the scope, applicability, or configuration of the invention.

What is claimed is:

1. A microelectromechanical systems (MEMS) device comprising:
a first movable mass;
a second movable mass; and
a spring system for coupling said first movable mass to said second movable mass, said spring system comprising:
a set of stiff beams oriented relative to one another to form a parallelogram arrangement, said beams being oriented diagonal to a drive direction of said first and second movable masses, wherein a first corner of said parallelogram arrangement is configured to couple to said first movable mass and a second corner of said parallelogram arrangement is configured to couple to said second movable mass, said second corner being diagonally opposite said first corner;
a first side spring coupled to a third corner of said parallelogram arrangement; and
a second side spring coupled to a fourth corner of said parallelogram arrangement, said fourth corner being diagonally opposite said third corner.

2. A MEMS device as claimed in claim 1 wherein said spring system further comprises:
a first flexure arrangement interconnecting a first beam and a second beam of said parallelogram arrangement at said first corner;
a second flexure arrangement interconnecting a third beam and a fourth beam of said parallelogram arrangement at said second corner;
a third flexure arrangement interconnecting said first beam and said third beam of said parallelogram arrangement at said third corner; and
a fourth flexure arrangement interconnecting said second beam and said fourth beam of said parallelogram arrangement at said fourth corner, wherein each of said first, second, third, and fourth flexure arrangements is rotationally compliant about an axis that is substantially perpendicular to a planar substrate of said MEMS device.

3. A MEMS device as claimed in claim 2 wherein said each of said first, second, third, and fourth flexure arrangements is axially stiff to substantially limit rotational movement of said first, second, third, and fourth flexure arrangements to a plane that is substantially parallel to said planar substrate.

4. A MEMS device as claimed in claim 1 wherein said parallelogram arrangement is configured to collapse when subjected to a drive signal to enable anti-phase motion of said first and second movable masses.

5. A MEMS device as claimed in claim 1 wherein said parallelogram arrangement is constrained to a non-collapsed configuration when subjected to an external vibration signal.

6. A MEMS device as claimed in claim 1 wherein said first and second side springs are stiff in said drive direction and compliant in a second direction that is orthogonal to said drive direction.

7. A MEMS device as claimed in claim 6 wherein said drive direction and said second direction are substantially parallel to a planar substrate of said MEMS device.

8. A MEMS device as claimed in claim 1 further comprising a frame surrounding said first and second movable masses, wherein opposing ends of each of said first and second side springs are adapted to interconnect with said frame.

9. A MEMS device as claimed in claim 1 further comprising a planar substrate, wherein said set of stiff beams, said first side spring, and said second side spring are suspended above said planar substrate without a direct connection to said planar substrate.

10. A method of fabricating a microelectromechanical systems (MEMS) device comprising:
forming a first movable mass, a second movable mass, and a sense frame surrounding said first and second movable masses on a planar substrate;
forming a spring system, said spring system including a set of stiff beams oriented relative to one another to form a parallelogram arrangement, a first side spring, and a second side spring; and
wherein said spring system is coupled to said first and second movable masses such that said beams are oriented diagonal to a drive direction of said first and second movable masses, wherein a first corner of said parallelogram arrangement is coupled to said first movable mass, a second corner of said parallelogram arrangement is coupled to said second movable mass, said second corner being diagonally opposite said first corner, and wherein said first side spring is coupled to a third corner of said parallelogram arrangement, said second side spring is coupled to a fourth corner of said parallelogram arrangement, said fourth corner being diagonally opposite said third corner.

11. A method as claimed in claim 10 wherein following said forming operations:
a first beam and a second beam of said parallelogram arrangement are interconnected at said first corner via a first flexure arrangement;
a third beam and a fourth beam of said parallelogram arrangement are interconnected at said second corner via a second flexure arrangement;
said first beam and said third beam of said parallelogram arrangement are interconnected at said third corner via a third flexure arrangement; and
said second beam and said fourth beam of said parallelogram arrangement are interconnected at said fourth corner via a fourth flexure arrangement, wherein each of said first, second, third, and fourth flexure arrangements is rotationally compliant about an axis that is substantially perpendicular to a planar substrate of said MEMS device.

12. A method as claimed in claim 10 wherein following said forming operations, opposing ends of each of said first and second side springs are interconnected to said sense frame.

13. A method as claimed in claim 10 wherein following said forming operations, said parallelogram arrangement is configured to collapse when subjected to a drive signal to enable anti-phase motion of said first and second movable masses, and said parallelogram arrangement is constrained to a non-collapsed configuration when subjected to an external vibration signal.

14. A method as claimed in claim 10 wherein said first and second side springs are stiff in said drive direction and compliant in a second direction that is orthogonal to said drive direction, said drive direction and said second direction being substantially parallel to a planar substrate of said MEMS device.

15. A method as claimed in claim 10 further comprising suspending said parallelogram arrangement, said first side spring, and said second spring above a planar substrate of said MEMS device without a direct connection to said planar substrate.

16. A microelectromechanical systems (MEMS) device comprising:
a substrate having a planar surface;
a sense frame suspended above and movably anchored to said planar surface, said sense frame having a central opening;
a first drive mass;
a second drive mass, said first and second drive masses being positioned within said central opening of said sense frame; and
a spring system configured to reduce in-phase motion of said first and second movable masses, said spring system including:
a set of stiff beams oriented relative to one another to form a parallelogram arrangement, said beams being oriented diagonal to a drive direction of said first and second movable masses, a first corner of said parallelogram arrangement being coupled to said first movable mass and a second corner of said parallelogram arrangement being coupled to said second movable mass, said second corner being diagonally opposite said first corner;
a first side spring coupled to a third corner of said parallelogram arrangement, and having first opposing ends interconnected with said sense frame; and
a second side spring coupled to a fourth corner of said parallelogram arrangement, and having second opposing ends interconnected with said sense frame, said fourth corner being diagonally opposite said third corner, said first and second side springs being stiff in said drive direction and compliant in a second direction that is orthogonal to said drive direction.

17. A MEMS device as claimed in claim 16 wherein said spring system further comprises:
a first flexure arrangement interconnecting a first beam and a second beam of said parallelogram arrangement at said first corner;
a second flexure arrangement interconnecting a third beam and a fourth beam of said parallelogram arrangement at said second corner;
a third flexure arrangement interconnecting said first beam and said third beam of said parallelogram arrangement at said third corner; and
a fourth flexure arrangement interconnecting said second beam and said fourth beam of said parallelogram arrangement at said fourth corner, wherein each of said first, second, third, and fourth flexure arrangements is rotationally compliant about an axis that is substantially perpendicular to said planar surface of said substrate.

18. A MEMS device as claimed in claim 17 wherein said each of said first, second, third, and fourth flexure arrangements is axially stiff to substantially limit rotational movement about said axis to a plane that is substantially parallel to said planar surface of said substrate.

19. A MEMS device as claimed in claim 16 wherein said parallelogram arrangement is configured to collapse when subjected to a drive signal to enable anti-phase motion of said first and second movable masses, and said parallelogram arrangement is constrained to a non-collapsed configuration when subjected to an external vibration signal.

20. A MEMS device as claimed in claim 16 wherein said drive direction and said second direction are substantially parallel to said planar surface of said substrate.
